(19) United States
(12) Patent Application Publication
(10) Pub. No.: US 2017/0286894 A1
(43) Pub. Date: Oct. 5, 2017

(54) SYSTEMS, METHODS, APPARATUSES, AND COMPUTER PROGRAM PRODUCTS FOR MANAGING AND PROVIDING FORMULAIC RATES

(71) Applicant: United Parcel Service of America, Inc., Atlanta, GA (US)

(72) Inventors: David Allison Bennett, Bothell, WA (US); Lynn Shaindell Goldhaber, Bellevue, WA (US); Jinyue Liu, Sammamish, WA (US); Hsiangwen S. Hu, Sammamish, WA (US)

(21) Appl. No.: 15/478,882

(22) Filed: Apr. 4, 2017

Related U.S. Application Data
(60) Provisional application No. 62/318,536, filed on Apr. 5, 2016.

(51) Int. Cl. G06Q 10/08; G06Q 30/02; G06Q 30/04; G06F 17/30

(52) U.S. Cl. CPC G06Q 10/083; G06F 17/30377; G06Q 30/0207; G06Q 30/04; G06Q 2250/10; G06Q 2250/60; G06Q 2250/80

(57) ABSTRACT

An apparatus is provided for generating formulaic rates. The apparatus may include at least one memory and a processor(s) configured to define a first formula(s) in a row(s) of a database to calculate a first shipping rate value for a first type of shipping rate, among plural types of shipping rates, associated with a first rate identifier. The processor is further configured to define content in the row to analyze a predecessor rate identifier(s) of a previously generated source. The processor is also configured to detect a second shipping rate value corresponding to the predecessor rate identifier. The second shipping rate value is associated with a second type of shipping rate. The processor is further configured to determine the first shipping rate value for the first type of shipping rate based on calculating the formula using the second shipping rate value. Corresponding computer program products and methods are also provided.

### CROSS-REFERENCE TO RELATED APPLICATIONS

This application is a non-provisional application of provisional U.S. Application No. 62/318,536, filed Apr. 5, 2016, the contents of which are hereby incorporated herein in its entirety by reference.

### BACKGROUND

Presently, carrier shipping systems typically utilize pre-calculated billing rates to determine static rate values for various different types of shipping rates. This static approach typically requires large amounts of data storage in a database(s) to store the static rate values for each of the various rate types, which may be associated with several (e.g., thousands) accounts.

Additionally, this static approach typically lacks dynamic flexibility in facilitating dynamic change or update of shipping rates to account for additional types of rates that may be needed for accounts of some shipping customers and for shipping customers that may desire shipping rate changes (e.g., contract discounts) based on, for example, shipping volume, etc.

Moreover, the large amounts of data storage associated with the static rate values for each of the different types of shipping rates may cause problems with conserving memory capacity of storage devices and may constrain processing capacity of electronic devices associated, in part, with querying large amounts of data. As such, a need may exist for improved systems and methods of determining shipping rates.

### BRIEF SUMMARY

The present invention provides methods, apparatuses and computer program products for efficiently generating one or more formulaic rates. In this regard, the exemplary embodiments may implement a technique that incorporates formulaic rating as a mechanism to maintain rates in a flexible manner, which may be more scalable (e.g., in relation to database management, etc.) and in a less computational intensive manner, while reducing a need to maintain and build rating engines to mimic every situation.

In one example embodiment, a method for generating one or more formulaic rates is provided. The method may include defining at least one first formula in at least one row of a database to calculate a first shipping rate value for a first type of shipping rate, among a plurality of types of shipping rates, associated with a first rate identifier. The method may further include defining content in the at least one row to analyze at least one predecessor rate identifier of a previously generated source of rates. The method may further include detecting a second shipping rate value corresponding to the predecessor rate identifier of the source of rates. The detected second shipping rate value is associated with a second type of shipping rate. The method may further include determining the first shipping rate value for the first type of shipping rate based in part on calculating the first formula using the second shipping rate value of the source of rates.

In another example embodiment, an apparatus for generating one or more formulaic rates is provided. The apparatus may include a processor and a memory including computer program code. The memory and computer program code are configured to, with the at least one processor, cause the apparatus to at least perform operations including defining at least one first formula in at least one row of a database to calculate a first shipping rate value for a first type of shipping rate, among a plurality of types of shipping rates, associated with a first rate identifier. The memory and computer program code are also configured to, with the processor, cause the apparatus to define content in the at least one row to analyze at least one predecessor rate identifier of a previously generated source of rates. The memory and computer program code are also configured to, with the processor, cause the apparatus to detect a second shipping rate value corresponding to the predecessor rate identifier of the source of rates. The detected second shipping rate value is associated with a second type of shipping rate. The memory and computer program code are also configured to, with the processor, cause the apparatus to determine the first shipping rate value for the first type of shipping rate based in part on calculating the first formula using the second shipping rate value of the source of rates.

In yet another example embodiment, a computer program product for generating one or more formulaic rates is provided. The computer program product includes at least one computer-readable storage medium having computer-executable program code instructions stored therein. The computer-executable program code instructions may include program code instructions configured to define at least one first formula in at least one row of a database to calculate a first shipping rate value for a first type of shipping rate, among a plurality of types of shipping rates, associated with a first rate identifier. The computer program product may further include program code instructions configured to define content in the at least one row to analyze at least one predecessor rate identifier of a previously generated source of rates. The computer program product may further include program code instructions configured to detect a second shipping rate value corresponding to the predecessor rate identifier of the source of rates. The detected second shipping rate value is associated with a second type of shipping rate. The computer program product may further include program code instructions configured to determine the first shipping rate value for the first type of shipping rate based in part on calculating the first formula using the second shipping rate value of the source of rates.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a mobile station according to one embodiment of the present invention.

FIG. 4 is a block diagram illustrating operations and processes that may be performed in accordance with various example embodiments.

### DETAILED DESCRIPTION OF THE INVENTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Exemplary System Architecture

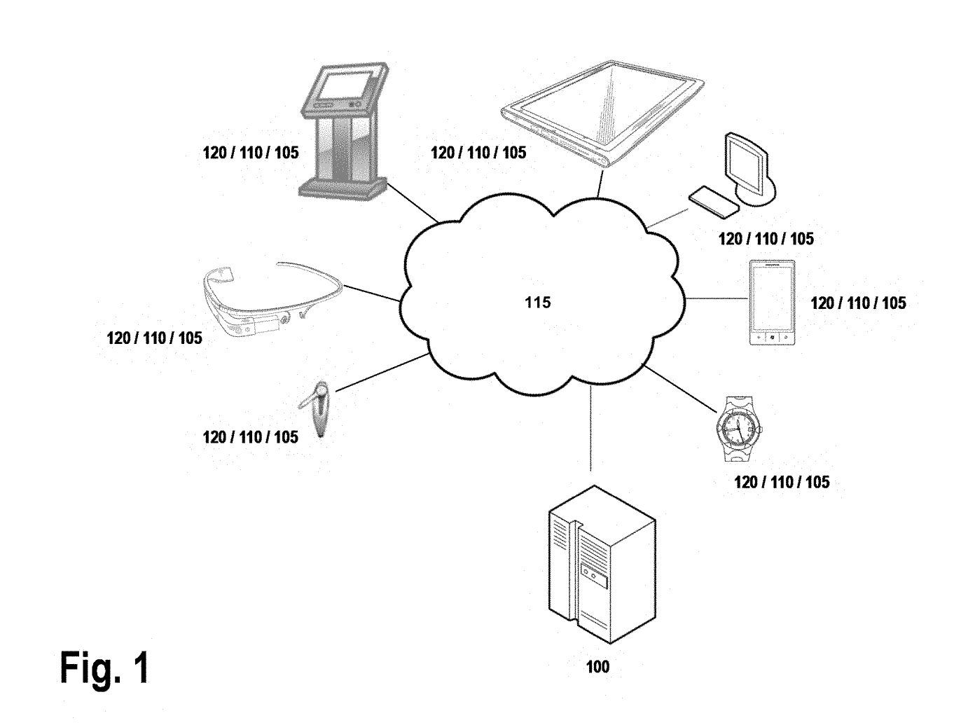

FIG. 1 provides an illustration of a system that can be used in conjunction with various embodiments of the present invention. As shown in FIG. 1, the system may include one or more carrier systems 100, one or more mobile stations 105, one or more compliance engine computing devices 110, and one or more networks 115, and one or more consignor computing devices 120. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain communication system entities as separate, standalone entities, the various embodiments are not limited to this particular architecture.

### 1. Exemplary Carrier System

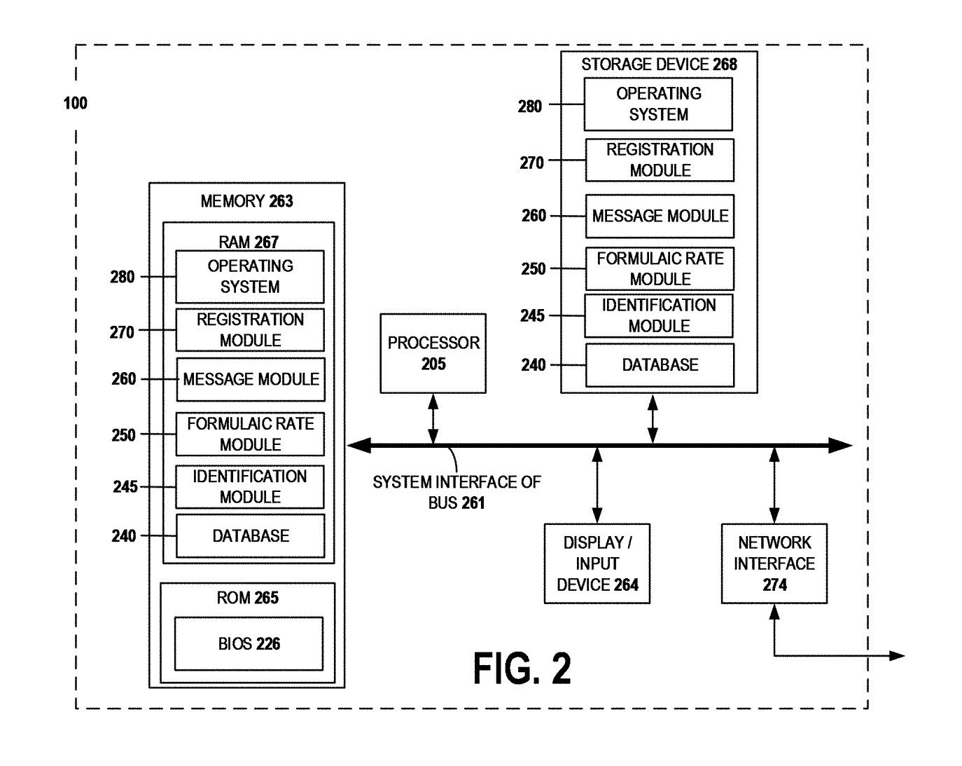

FIG. 2 provides an exemplary schematic of a carrier system 100 according to one embodiment of the present invention. In general, the term “system” may refer to, for example, one or more computers, computing entities, computing devices, mobile phones, gaming consoles (e.g., Xbox, Play Station, Wii), desktops, tablets, notebooks, laptops, distributed systems, servers or server networks, blades, gateways, switches, processing devices, processing entities, set-top boxes, relays, routers, network access points, base stations, the like, and/or any combination of devices or entities adapted to perform the functions, operations, and/or processes described herein. However, the carrier system 100 may also comprise various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components. The carrier system 100 may also be in communication with various payment networks/systems for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like.

As will be understood from FIG. 1, in one embodiment, the carrier system 100 includes one or more processors 205 that communicate with other elements within the carrier system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the carrier system 100. This display device/input device 264 may be, for example, a keyboard or pointing device that is used in combination with a monitor. The carrier system 100 may further include transitory and non-transitory memory 263, which may include both random access memory (RAM) 267 and read only memory (ROM) 265. The carrier system's ROM 265 may be used to store a basic input/output system (BIOS) 226 containing the basic routines that help to transfer information to the different elements within the carrier system 100.

In addition, in one embodiment, the carrier system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, a registration module 270, a message module 260, a formulaic rate module 250, an identification module 245, and/or the like. As discussed in more detail below, these executable instructions, applications, program modules, and/or the like may control certain aspects of the operation of the carrier system 100 with the assistance of the processor 205 and operating system 280—although their functionality need not be modularized. In addition to the program modules, the carrier system 100 may store or be in communication with one or more databases, such as database 240.

In an exemplary embodiment, the processing element 205 may be in communication with and may otherwise control the formulaic rate module 250. The formulaic rate module 250 may operate in accordance with software embodied in memory (e.g., memory 263, storage device 268) to perform the corresponding functions of the formulaic rate module 250, as described below. In examples in which software is employed, a device or circuitry (e.g., processing element 205 in one example) executing the software forms the structure associated with such means. As such, for example, the formulaic rate module 250 may be configured to, among other things, facilitate generation of one or more formulaic rates, as described more fully below.

Also located within the carrier system 100, in one embodiment, is a network interface 274 for interfacing with various computing entities (e.g., with one or more mobile stations 105). For example, the carrier system 100 may be able to receive data and/or messages from and transmit data and/or messages to the mobile station 105, compliance engine computing devices 110, and consignor computing devices 120. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the carrier system's 100 components may be located remotely from other carrier system 100 components. Furthermore, one or more of the components may be combined and additional components performing functions described herein may be included in the carrier system 100.

### 2. Exemplary Mobile Station

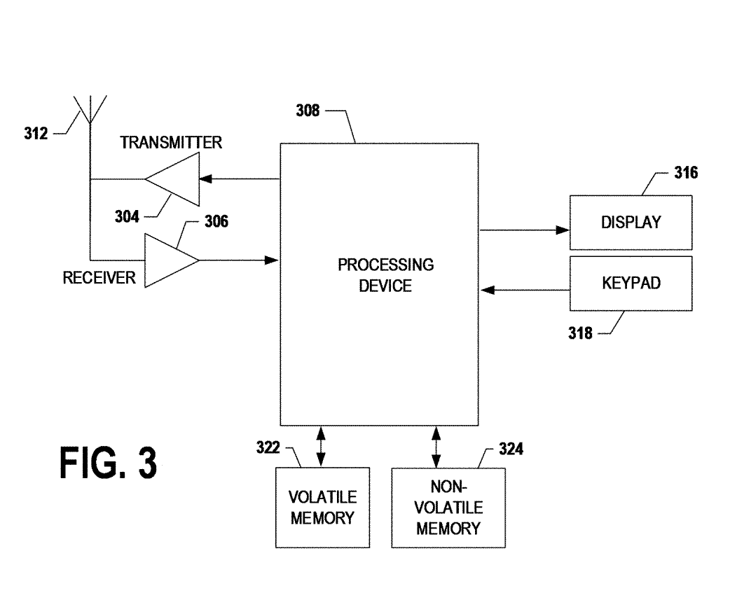

FIG. 3 provides an illustrative schematic representative of a mobile station 105 that can be used in conjunction with the embodiments of the present invention. Mobile stations 105 can be operated by various parties, including carrier personnel (e.g., delivery drivers, sorters, and/or the like). As shown in FIG. 3, the mobile station 105 can include an antenna 312, a transmitter 304 (e.g., radio), a receiver 306 (e.g., radio), and a processing device 308 (e.g., a processor, controller, and/or the like) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile station 105 may be capable of operating with one or more air interface standards, communication protocols, modulation types, and access types. More particularly, the mobile station 105 may operate in accordance with any of a number of wireless communication standards and protocols, such as those described above with regard to the carrier system 100. In a particular embodiment, the mobile station 105 may operate in accordance with multiple wireless communication standards and protocols (e.g., using a Gobi radio), such as such as 802.11, GPRS, UMTS, CDMA2000, 1×RTT, WCDMA, TD-SCDMA, LTE, E-UTRAN, EVDO, HSPA, HSDPA, Wi-Fi, WiMAX, UWB, IR, Bluetooth™, wireless USB protocols, and/or any other wireless protocol and/or multiple wireless carriers. To do so, the mobile station 105 may include integrated mobile reception diversity and integrated power management. Such a configuration can provide for global connectivity to the user.

Via these communication standards and protocols, the mobile station 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 105 can also download changes, add-ons, and updates, for instance, to its firmware, software (e.g., including executable instructions, applications, program modules), and operating system.

According to one embodiment, the mobile station 105 may include a location determining device and/or functionality. For example, the mobile station 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 105 may also comprise a user interface (that can include a display 316 coupled to a processing device 308) and/or a user input interface (coupled to the processing device 308). The user input interface can comprise any of a number of devices allowing the mobile station 105 to receive data, such as a keypad 318, a touch display, voice or motion interfaces, or other input device. In embodiments including a keypad 318, the keypad 318 can include the conventional numeric (0-9) and related keys (#, *), and other keys used for operating the mobile station 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 105 can also include volatile memory 322 and/or non-volatile memory 324, which can be embedded and/or may be removable. For example, the non-volatile memory may be embedded or removable MMCs, secure digital SD memory cards, Memory Sticks, EEPROM, flash memory, hard disk, or the like. The memory can store any of a number of pieces or amount of information and data used by the mobile station 105 to implement the functions of the mobile station 105. The memory can also store content, such as computer program code for an application and/or other computer programs.

### 3. Exemplary Compliance Engine Computing Device

The compliance engine computing devices 110 may each include one or more components that are functionally similar to those of the carrier system 100 and/or mobile station 105. For example, in one embodiment, each of the compliance engine computing devices may include: (1) a processor that communicates with other elements via a system interface or bus; (2) a user interface; (3) transitory and non-transitory memory; and (4) a communications interface. As noted, the compliance engine computing device 110 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the compliance engine computing device 110 to interact with and/or cause display of information from the carrier system 100, as described herein. These architectures are provided for exemplary purposes only and are not limiting to the various embodiments. In general, the terms device, system, computing entity, entity, and/or similar words used herein interchangeably may refer to, for example, one or more computers, computing entities, mobile phones, desktops, tablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. In one example embodiment, the compliance engine computing device 110 may be a network device (e.g., a server) that determines rates (e.g., shipping rates (e.g., a published shipping rate(s), a contract shipping rate(s), a retail shipping rate(s), etc.)) based on the compliance engine computing device's 110 own set of rules and may provide the rates to communication devices (e.g., carrier system 100) of shipping systems for usage in setting their rates, as described more fully below.

### 4. Exemplary Consignor Computing Device

The consignor computing devices 120 may each include one or more components that are functionally similar to those of the carrier system 100, mobile station 105, and/or compliance engine computing device 110. For example, in one embodiment, each of the consignor computing devices may include: (1) a processor that communicates with other elements via a system interface or bus; (2) a user interface; (3) transitory and non-transitory memory; and (4) a communications interface. As noted, the consignor computing device 120 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the consignor computing device 120 to interact with and/or cause display of information from the carrier system 100, as described herein. These architectures are provided for exemplary purposes only and are not limiting to the various embodiments. A customer may refer to a consignor (e.g., a party shipping an item via carrier), a consignee (e.g., a party receiving an item from a carrier) a third party, and/or the like. In the returns context, a consignor who shipped an item can become a consignee when an item is being returned.

### III. Shipping System Rate Overview

At present, in a conventional shipping system, pre-calculated rates may typically be used to determine rate static values. These rate static values may be denoted, for example, in a table such as TABLE A below.

The data of TABLE A may be represented in a database as a series of rows and in which there may be content indicating key values, service (e.g., a ground shipping service), weight (e.g., 1 pound (lb.), 2 lbs., 3 lbs. , 4 lbs., 5 lbs.), zones (e.g., Zone 2, Zone 3, Zone 4), etc. that may be used to determine one or more rates such as, for example, the rates in TABLE B set forth below.

Each value that is part of a rate (e.g., $8.01, $8.50, $8.67, $8.52, $9.07, $9.83, etc.) is generally then added with other charges such as, for example, surcharges, service options, etc. to obtain the final charge to a shipping customer. This process is typically done for each rate type, such as, for example, a published rate, a contract rate and a retail rate charged to a shipping customer. The published rate, may be a rate that a carrier publishes to the world as their base rate, which may serve as a value that is the base or basis of all other rates of a carrier. The contract rate may be a rate that the carrier provides as the basis of a contract with a shipping customer that ships a certain volume of shipments which may entail a discount from the published rate (e.g., a $2.00 discount off, or a percentage off (e.g., 20% off) a published rate of $8.00). The retail rate may involve a rate provided to resellers of carrier services (e.g., The UPS Store™, Staples™, etc.). The resellers may be entities that desire to resell the shipping services of the carrier to other customers.

If a shipping system does not support the concept of a rate type, the shipping system may be restricted to a single rate that the shipping system may utilize.

At present, existing shipping systems may experience problems in instances in which more types of rates need to be calculated than are typically available in conventional rating systems. For example, consider a company that manages accounts on behalf of their franchisees, but also relies on their franchisees to save money on shipping rates and to thereby increase profits for shipping. In this example, consider that from the published rate the company received a contract rate discount such as, for example, a 40% discount, but the company desires only to pass on 30% of that discount to their franchisees. Furthermore, consider that the franchisees then desire to resell the shipping service to their customers at a markup rate, for example, a retail rate. In this example, a shipping system may need four types of rates (e.g., a published rate, a contract rate, a franchisee rate, a retail rate) to provide the company, but only three types of rates (e.g., published rates, contract rates, retail rates) are typically available in traditional/conventional carrier systems. As such, a need may exist for an improved system that provides more types of rates based on customers' needs.

Another problem encountered by existing shipping systems may pertain to adding more carriers and services for which rates may need to be provided. As more carriers and services are added, a shipping system may need to rely on external sources of published rate data.

For example, as more carriers and services are added for providing shipping services, a shipping system may encounter more complex contracts and may be unable to obtain or derive an originating published rate or an originating contract rate because the rules of these systems for determining the originating published rate or originating contract rate may be difficult to replicate without prior knowledge of the rules. Furthermore, the shipping system may not desire to build an entire rating system to determine a carrier's published rate because the carrier may have some complex or obscure rules that are difficult to replicate.

However, without mimicking the entire rating rules structure of a carrier, the shipping system may be unable to determine the values for rate types (e.g., contract, retail, or other rate types) as needed. As such, an improved system may be needed that obtains rate values from an external source, which may have databases and rules to determine rate values (e.g., published rates, etc.). Once these rate values are obtained from the external source, an improved system may be able to utilize these rate values to derive other rate values (e.g., contract rates, retail rates, etc.), as described more fully below.

Another problem encountered by current shipping systems may relate to scale. For example, as a shipping system grows, the shipping system may encounter customers having rate values that change based upon volume or other transitory values. The discounts of these customers may change according to these values and may be represented as “tiers” in their carrier contracts. An example contract may have five tiers represented in increments of 5%. For instance, Tier 1=5%, Tier 2=10%, Tier 3=15%, Tier 4=20% and Tier 5=25%. In a pre-calculated rate approach utilized by some existing systems, this may represent five complete sets of rates that typically may need to be calculated and stored for a customer. These five sets of rates for the customer may result in a significant increase in data that needs to be stored in a database. To complicate matters, each shipping location of the customer may have a different retail rate, calculated against the contract rate. For instance, the customer may have hundreds or thousands of locations which now may have five times the potential number of retail rates (e.g., based on the five tiers). As such, unless the shipping system restricts or limits the number of pre-calculated rates the vast number of rate sets may impact the shipping systems ability to adequately maintain and store the rate data. Accordingly, an improved system may be needed to adequately and flexibly maintain rate data.

### IV. Exemplary System Operation

Reference will now be made to example embodiments of a system overcoming the aforementioned problems and which provides approaches that provides formulaic rating as a mechanism to determine and maintain rates in a flexible and reliable manner and accommodates needs of customers in a more scalable and less computationally intensive manner, while reducing a need to maintain and build rating engines to mimic rating rules of each carrier to calculate shipping rates. By utilizing formulaic rating approaches, the example embodiments may also address problems associated with constraining memory resources and diminishing processing capacity of processing devices, as described more fully below.

The example embodiments may also define a rate(s) to include additional data to point to predecessors, include ranges and allow for different types of rates (e.g., discounts or markups). The example embodiments may also define the usage of one or more rates.

Additionally, although the example embodiments below may relate to shipping rate examples, for purposes of illustration and not of limitation, it should be pointed out that the formulaic rate approach of the example embodiments may also be utilized by systems (e.g., telecommunication systems to determine cellular/data rates, etc.) other than shipping systems without departing from the spirit and scope of the invention.

### 1. Assigning Rate IDs to Rates

In various example embodiments of the invention, a shipping system (e.g., carrier system 100) may define each set of rates that a carrier(s) needs to support by an identifier (ID), which may be associated with a customer account(s). Each ID may represent a different type of rate such as, for example, a published rate, a contract rate or a retail rate, as shown in TABLE C, set forth below.

TABLE C

| | | | | |
|---|---|---|---|---|
| Rate ID | Service | Weight | Zones | Rate |

| | | | | | |
|---|---|---|---|---|---|
| 10 | Ground | 1 | 2 | $8.00 | <- Published |
| 1010 | Ground | 1 | 1 | $6.00 | <- Contract |
| 101234 | Ground | 1 | 4 | $9.00 | <- Retail |

The shipping system (e.g., carrier system 100) may then process each rate type separately to determine the rates/values and may store each separately in a database (e.g., database 240). The use of a rate ID may allow the shipping system (e.g., carrier system 100) to also associate the rate ID with several (e.g., thousands) accounts tied to the same set of rates, thereby saving significant storage space and allowing caching processes to speed processing by communication devices.

For instance, consider an example in which a carrier may have a single published rate that applies to all shipping stores and that the carrier has a recommended contract rate that the carrier applies to all of the stores and presume for example there are 4,600 stores. In this example, the shipping system may take the rates that comprise the published rate and assign them a rate ID, such as rate ID 10 (as set forth in TABLE C above). The system may also assign a rate ID of 1010 (as set forth in TABLE C above) for the contract rate of each of the 4,600 stores. As such, the database storage of the system may be optimized

For instance, instead of having 4,600 rows of published values for the 4,600 stores published rate sets, and 4,600 rows for the 4,600 stores contract rate sets stored in a database (e.g., database 240), the shipping system (e.g., carrier system 100) may store two corresponding rate sets related to rate ID 10 and rate ID 1010 as opposed to storing 9,200 (e.g., 4,600×2 (e.g., for the published rate and the contract rate)) rate sets. In other words, instead of having 9,200 rows of rate sets in a database, the shipping system (e.g., carrier system 100) may store, in the database (e.g., database 240), two corresponding rate sets for the published rate and the contract rate of the 4,600 stores in this example. This approach of assigning rate IDs to entities for rate types may, in some respects, conserve memory capacity of storage devices and may conserve processing capacity of communication devices (e.g., carrier system 100), in part, by not requiring processing devices to query as much data and constrain processing resources.

However, as the number of customers of a shipping system increases and multiple tiers (e.g., Tier 1=5% off, Tier 2=10% off, etc.) of contracts are provided for customers, the usage of rate IDs alone may, in some circumstances, result in large amounts of data relating to rate sets being stored in a database(s), which may be difficult to manage and maintain. As such, the example embodiments may incorporate formulaic rating to maintain rate sets in a more efficient and reliable manner, as described more fully below.

### 2. Assigning Formulaic Rates

In various example embodiments, a carrier system (e.g., carrier system 100) may utilize a formulaic approach for calculating a rate(s). For purposes of illustration and not of limitation, consider TABLE D and TABLE E, set forth below.

TABLE D

| Rate ID | Service | Weight | Zones | Rate | |
|---|---|---|---|---|---|
| 10 | Ground | 1 | 2 | $8.00 | <- used as |
| | | | | | Published |
| 1010 | Ground | 1 | 2 | $6.00 | <- used as |
| | | | | | Contract |
| 101234 | Ground | 1 | 2 | $9.00 | <- used as Retail |

TABLE E

| Rate | | | Weight | Weight | Zone | Zone | Predecessor | |
|---|---|---|---|---|---|---|---|---|
| ID | Type | Service | Start | End | Start | End | Rate ID | Rate |
| 1010 | Contract | Ground | 1 | 10 | 2 | 4 | 10 | −25% |
| 101234 | Retail | Ground | 1 | 10 | 2 | 4 | 1010 | +50% |

In this example embodiment, a processor (e.g., processor 105) and/or the formulaic rate module 250 of a communication device (e.g., carrier system 100) may define rows (cell-by-cell) (e.g., in TABLE E) of a database (e.g., database 240 of memory 263 or of storage device 268) specifying formulas and other criteria (e.g., type of service, a range of weights, a range of zones, predecessor rate IDs, etc.) for determining shipping rates such as, for example, a contract rate and a retail rate, as shown in TABLE E above. Additionally, in this example embodiment, the first row of TABLE E may indicate to determine the contract rate associated with rate ID 1010 by analyzing/referring to predecessor rate ID 10 corresponding to the published rate of $8.00, for a weight of an item (e.g., a package(s)) of 1 lb. in zone 2, of a predecessor table such as, for example, TABLE D. Furthermore, the formulaic rate value of the first row of TABLE E may indicate to calculate a 25% discount off (e.g., −25%) of the publication rate (e.g., $8.00) corresponding to predecessor rate ID 10.

In this regard, the processor (e.g., processor 205) and/or the formulaic rate module 250 of the communication device (e.g., carrier system 100) may determine that the contract rate is $6.00 (e.g., −25% of $8.00=$2.00; $8.00−$2.00=$6.00) for rate ID 1010. Moreover, the formulaic rate value of the second row of TABLE E may indicate to calculate a 50% markup (e.g., +50%) of the determined contract rate (e.g., $6.00) corresponding to predecessor rate ID 1010 to determine the retail rate. As such, the processor (e.g., processor 205) and/or the formulaic rate module 250 of the communication device (e.g., carrier system 100) may determine that the retail rate of the corresponding row in the database (e.g., database 240) for example, the second row in the TABLE E is $9.00 (e.g., +50% of $6.00=$3.00; $6.00+$3.00=$9.00) for rate ID 101234.

Although formulas such as −25% and +50% were utilized, as examples, in TABLE E for determining a contract rate and a retail rate for purposes of illustration and not of limitation, it should be pointed out that any suitable formulas may be utilized, including, but not limited to, a value (e.g., $2.00 minus a predecessor rate value associated with a predecessor ID), a percentage of a rate value (e.g., $2.00 minus±10% of a predecessor rate value associated with a predecessor ID), a pointer to a value stored in a remote memory device (e.g., volatile memory 322, non-volatile memory 324 of mobile station 105) and any other suitable formulas.

Additionally, by utilizing the formulaic rate determination approach of TABLE E, there may be two rows in a database (e.g., database 240) corresponding to the contract rate and retail rate (e.g., pertaining to ranges of weights between 1 lb. to 10 lbs. and zones 2, 3, 4). On the other hand, with TABLE D there may be one row for each ID, weight and zone which may correspond to 60 different rows in a database. For instance, weight values from 1 to 10 pounds (e.g., 10 values) for zones 2, 3, 4 (e.g., 3 values) equals 30 rows (e.g., 10×3=30) corresponding to a contract rate. Likewise, weight values from 1 to 10 pounds (e.g., 10 values) for zones 2, 3, 4 (e.g., 3 values) equals 30 additional rows (e.g., 10×3=30) corresponding to a retail rate which totals 60 rows (e.g., 30+30=60) for a conventional shipping system as opposed to two corresponding rows in a database (e.g., database 240) according to various exemplary embodiments.

Furthermore, for example, consider that the customer contract changed for the contract rate and retail rate each year for 5 years this may correspond to 300 rows of data (e.g., 60×5=300) in a database of a conventional shipping system whereas the corresponding two rows of the exemplary embodiments may remain in place over the 5 years in the database (e.g., database 240) according to the exemplary embodiments. In this regard, the exemplary embodiments may decrease the amount of rate data of a database (e.g., database 240) of memory devices (e.g., memory 263, storage device 268) thereby conserving memory resources.

As such, exemplary embodiments may conserve memory capacity and resources of storage devices (e.g., database 240, memory 263, storage device 268) and may conserve bandwidth of processing devices (e.g., processor 205) and enable enhancement (e.g., increased) of processing speed based in part on minimizing/reducing querying of large amounts of data.

Additionally, since the amount of data pertaining to rates may be reduced by the exemplary embodiments for periods of time (e.g., over the span of a contract in some instances), the rate data of the exemplary embodiments may be less error prone given that the rate data may not need to change each year of a contract and may not need to be reevaluated. In other words, the data may not need to be altered, which may minimize exposure to introduce data errors.

In some other example embodiments, the formulaic approach of the example embodiments may be flexible enough that even in instances in which a published rate value was not previously stored (e.g., in a database (e.g., database 240) of a memory (e.g., memory 263 or storage device 268)), a processor (e.g., processor 205) and/or the formulaic rate module 250 of a communication device (e.g., carrier system 100) may receive/obtain an external value (e.g., a publication rate value) from an external compliance engine (e.g., compliance engine computing device 110). The received external value may be utilized by a processor (e.g., processor 205) and/or the formulaic rate module 250 of a communication device (e.g., carrier system 100) to determine other rates (e.g., a contract rate, a retail rate, etc.), as described more fully below. The external compliance engine (e.g., compliance engine computing device 110) may have its own set of rules for determining rate values (e.g., a publication rate(s), a contract rate(s), a retail rate(s), etc.).

For purposes of illustration and not of limitation, consider an example in which a processor (e.g., processor 205) and/or the formulaic rate module 250 of a communication device (e.g., carrier system 100) determines that there is no published rate value currently stored in a memory or database of the communication device from which to derive/calculate other rate values (e.g., a contract rate value, a retail rate value, etc.). As such, the processor and/or the formulaic rate module 250 may analyze the content of a formulaic defined row, such as for example in TABLE G, defined such that the predecessor rate ID specifies to refer to an external source to obtain a rate(s) (e.g., a publication rate value(s)) from the external source in order to determine a contract rate. In this regard, the processor (e.g., processor 205) and/or the formulaic rate module 250 of the communication device (e.g., carrier system 100) may send a request for a publication rate value(s) to an external compliance engine (e.g., compliance engine computing device 110).

In response to the sent request for the publication rate value(s), the processor (e.g., processor 205) and/or the formulaic rate module 250 of the communication device (e.g., carrier system 100) may receive one or more rows of a database of a table such as, for example, TABLE F, set forth below, from an external compliance engine (e.g., compliance engine computing device 110) indicating one or more publication rate values (e.g., $8.00, $8.50).

TABLE F

| | | | Weight | Weight | Zone | Zone | Predecessor | |
|---|---|---|---|---|---|---|---|---|
| Rate ID | Type | Service | Start | End | Start | End | Rate ID | Rate |
| 10 | Published | Ground | 1 | 1 | 2 | 2 | — | $8.00 |
| 10 | Published | Ground | 1 | 1 | 3 | 3 | — | $8.50 |

As such, the processor (e.g., processor 205) and/or the formulaic rate module 250 of a communication device (e.g., carrier system 100) may calculate the formulaic rate for a contract rate associated with rate ID 1010 indicated in a row of a database (e.g. database 240) denoted in TABLE G, set forth below, based on the publication rate value(s) received from the external compliance engine (e.g., compliance engine computing device 110). Accordingly, the processor (e.g., processor 205) and/or the formulaic rate module 250 of a communication device (e.g., carrier system 100) may apply the formulaic rate (e.g., −25%) of the row of a database denoted in TABLE G and may determine/calculate that the contract rate for a weight of 1 lb. for a zone (e.g., zone 2) is $6.00 (e.g., −25% of $8.00=$2.00; $8.00−$2.00=$6.00).

TABLE G

| | | | Weight | Weight | Zone | Zone | Predecessor | |
|---|---|---|---|---|---|---|---|---|
| Rate ID | Type | Service | Start | End | Start | End | Rate ID | Rate |
| 1010 | Contract | Ground | 1 | 10 | 2 | 4 | External | −25% |

Alternatively, in some other example embodiments, the processor (e.g., processor 205) and/or the formulaic rate module 250 of a communication device (e.g., carrier system 100) may apply the formulaic rate (e.g., −25%) of the row of the database denoted in TABLE G to determine/calculate that the contract rate for a weight of 1 lb. for a zone (e.g., zone 3) is $6.38 (e.g., −25% of $8.50=$2.125; $8.50−$2.125≈$6.38).

Furthermore, in some example embodiments, predecessors may be mixed such that a processor (e.g., processor 205) and/or the formulaic rate module 250 of a communication device (e.g., carrier system 100) may obtain a predecessor rate value(s) from a stored row of a database of the communication device for one type of rate value (e.g., a contract rate value, etc.) and may obtain another predecessor rate value(s) from an external source for another type of rate value (e.g., a retail rate value, etc.). Additionally, in some exemplary embodiments one or more custom rate types may be defined by a carrier system (e.g., carrier system 100) in a row of a database and may utilize a formulaic rating along with data pointing to a predecessor (e.g., a predecessor rate ID) and other data (e.g., type of service, ranges of weights, ranges of zones) to determine a custom rate(s) (e.g., a franchisee rate or other rates) based on a need of a customer(s).

By the various exemplary embodiments building a chain of formulas, entire rate sets may be maintained more efficiently and accurately. Furthermore, each year carriers may change their published rates which may result in the need to recalculate contract rates, retail rates and any other derived rates in conventional shipping systems. However, the work to recalculate rates may now eliminated or greatly reduced with exemplary embodiments of the invention, as described above. Moreover, with the ability to use an external rate source, various exemplary embodiments may provide contract, retail and other rate values, as described above, for any carrier for which a rate source is available, thereby enabling a shipping system of the exemplary embodiments to expand its offerings/services.

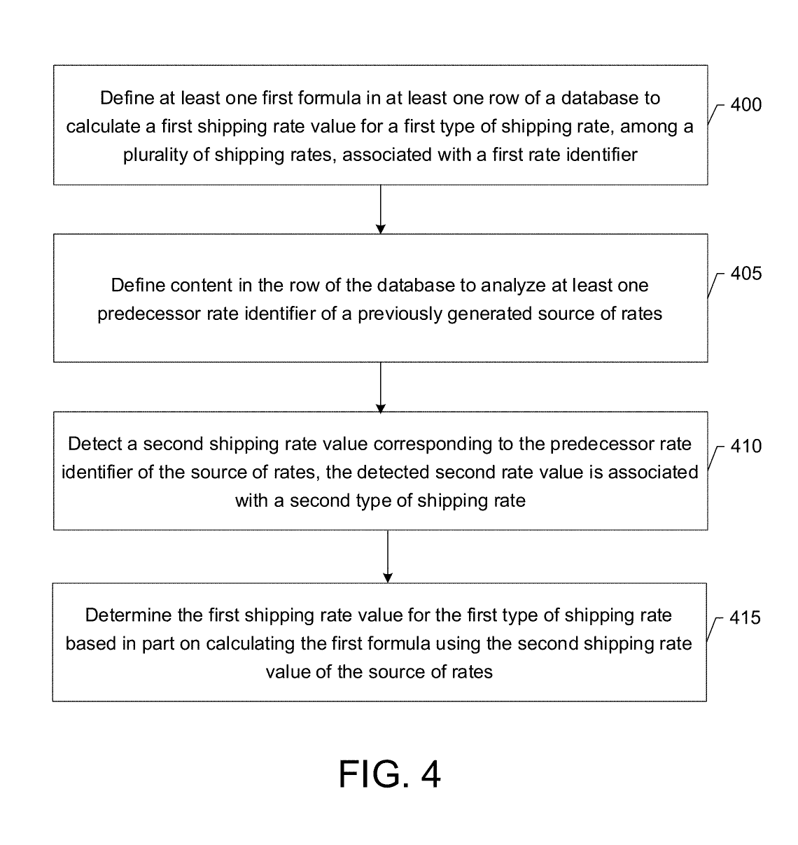

Referring now to FIG. 4, an example embodiment of a flowchart for generating formulaic shipping rates is provided according to an example embodiment. At operation 400, an apparatus (e.g., carrier system 100) may define at least one first formula (e.g., −25% off of a rate value) in at least one row (e.g., a row of TABLE E) of a database (e.g., database 240) to calculate a first shipping rate value for a first type of shipping rate (e.g., a contract type shipping rate), among a plurality of types of shipping rates (e.g., a published type shipping rate, a contract type shipping rate, a retail type shipping rate, etc.). The first type of shipping rate (e.g., a contract type shipping rate) may be associated with a first rate identifier (e.g., rate ID 1010).

At operation 405, the apparatus (e.g., carrier system 100) may define content in the row of the database to analyze at least one predecessor rate identifier (e.g., rate ID 10) of a previously generated source of rates. In some exemplary embodiments, the previously generated source of rates (e.g., a publication rate value(s), a contract rate value(s), a retail rate value(s) (e.g., of TABLE D)) may be previously generated by the apparatus (e.g., carrier system 100) and stored in a memory (e.g., memory 263, storage device 268) of the apparatus. In some other exemplary embodiments, the previously generated source of rates may be obtained/received by the apparatus (e.g., carrier system 100) from an external device (e.g., compliance engine computing device 110).

At operation 410, the apparatus (carrier system 110) may detect a second shipping rate value (e.g., a published shipping rate value (e.g., $8.00)) corresponding to the predecessor rate identifier (e.g., rate ID 10) of the source of rates. The detected second shipping rate value may be associated with a second type of shipping rate (e.g., a published type of shipping rate).

At operation 415, the apparatus (e.g., carrier system 100) may determine the first shipping rate value (e.g., $6.00) for the first type of shipping rate based in part on calculating the first formula (e.g., −25% (e.g., −25%×$8.00=$2.00)) using the second shipping rate value (e.g., $8.00 (e.g., $8.00−$2.00=$6.00)) of the source of rates.

It should be pointed out that FIG. 4 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions.

### V. Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
defining, via at least one processor of a communication device, at least one first formula in at least one row of a database to calculate a first shipping rate value for a first type of shipping rate, among a plurality of types of shipping rates, associated with a first rate identifier;
defining, via the processor, content in the at least one row to analyze at least one predecessor rate identifier of a previously generated source of rates;
detecting, via the processor, a second shipping rate value corresponding to the predecessor rate identifier of the source of rates, the detected second shipping rate value is associated with a second type of shipping rate; and
determining, via the processor, the first shipping rate value for the first type of shipping rate based in part on calculating the first formula using the second shipping rate value of the source of rates.

2. The method of claim 1, wherein:
the second type of shipping rate corresponds to a published type shipping rate that a shipping carrier publishes as a base shipping rate.

3. The method of claim 2, wherein:
the first type of shipping rate corresponds to a contract type shipping rate corresponding to a discount off of the published type shipping rate.

4. The method of claim 1, further comprising:
defining in another row of the database a second formula to calculate a third shipping rate value for a third type of shipping rate, among the plurality of types of shipping rates, associated with a second rate identifier;
defining content in the another row to analyze at least one other predecessor rate identifier which comprises the first rate identifier;
detecting the determined first shipping rate value corresponding to the first rate identifier in response to analyzing the at least one other predecessor rate identifier; and
determining the third shipping rate value for the third type of shipping rate based in part on calculating the second formula using the determined first shipping rate value for the first type of shipping rate.

5. The method of claim 4, wherein:
the third type of shipping rate corresponds to a retail type shipping rate pertaining to a markup of the first shipping rate value for the first type of shipping rate.

6. The method of claim 5, wherein:
the at least one row and the another row of the database denotes that the first shipping rate value and the third shipping rate value are applicable for a type of shipping service, a range of weights of an item for shipment and a range of delivery zones.

7. The method of claim 1, further comprising:
receiving the source of rates from a memory of the communication device.

8. The method of claim 1, wherein:
the at least one predecessor rate identifier indicates an external source from which to obtain the second shipping rate value comprising a published shipping rate value.

9. The method of claim 8, further comprising:
receiving the source of rates from an external device in response to sending the external device a request for a published rate value, the external device utilizes one or more rules and analyzes data to determine the source of rates comprising one or more published rate values.

10. The method of claim 9, wherein prior to receiving the source of rates, the method further comprises:
determining that no prior determined published rate value was stored in a memory of the communication device; and
analyzing the at least one predecessor rate identifier indicating the external source from which to obtain the second shipping rate value comprising the published shipping rate value.

11. An apparatus comprising at least one processor and at least one memory including computer program code, the at least one memory and the computer program code configured to, with the processor, cause the apparatus to at least:
define at least one first formula in at least one row of a database to calculate a first shipping rate value for a first type of shipping rate, among a plurality of types of shipping rates, associated with a first rate identifier;
define content in the at least one row to analyze at least one predecessor rate identifier of a previously generated source of rates;
detect a second shipping rate value corresponding to the predecessor rate identifier of the source of rates, the detected second shipping rate value is associated with a second type of shipping rate; and
determine the first shipping rate value for the first type of shipping rate based in part on calculating the first formula using the second shipping rate value of the source of rates.

12. The apparatus of claim 11, wherein:
the second type of shipping rate corresponds to a published type shipping rate that a shipping carrier publishes as a base shipping rate.

13. The apparatus of claim 12, wherein:
the first type of shipping rate corresponds to a contract type shipping rate corresponding to a discount off of the published type shipping rate.

14. The apparatus of claim 11, wherein the memory and computer program code are further configured to, with the processor, cause the apparatus to:
define in another row of the database a second formula to calculate a third shipping rate value for a third type of shipping rate, among the plurality of types of shipping rates, associated with a second rate identifier;
define content in the another row to analyze at least one other predecessor rate identifier which comprises the first rate identifier;
detect the determined first shipping rate value corresponding to the first rate identifier in response to analyzing the at least one other predecessor rate identifier; and
determine the third shipping rate value for the third type of shipping rate based in part on calculating the second formula using the determined first shipping rate value for the first type of shipping rate.

15. The apparatus of claim 14, wherein:
the third type of shipping rate corresponds to a retail type shipping rate pertaining to a markup of the first shipping rate value for the first type of shipping rate.

16. The apparatus of claim 15, wherein:
the at least one row and the another row of the database denotes that the first shipping rate value and the third shipping rate value are applicable for a type of shipping service, a range of weights of an item for shipment and a range of delivery zones.

17. The apparatus of claim 11, wherein the memory and computer program code are further configured to, with the processor, cause the apparatus to:
receive the source of rates from the memory of the apparatus.

18. The apparatus of claim 11, wherein:
the at least one predecessor rate identifier indicates an external source from which to obtain the second shipping rate value comprising a published shipping rate value.

19. The apparatus of claim 18, wherein the memory and computer program code are further configured to, with the processor, cause the apparatus to:
receive the source of rates from an external device in response to sending the external device a request for a published rate value, the external device utilizes one or more rules and analyzes data to determine the source of rates comprising one or more published rate values.

20. The apparatus of claim 19, wherein prior to receive the source of rates, the memory and computer program code are further configured to, with the processor, cause the apparatus to:
determine that no prior determined published rate value was stored in the memory of the apparatus; and
analyze the at least one predecessor rate identifier indicating the external source from which to obtain the second shipping rate value comprising the published shipping rate value.

21. A computer program product comprising at least one non-transitory computer-readable storage medium having computer-executable program code instructions stored therein, the computer-executable program code instructions comprising:
program code instructions configured to define at least one first formula in at least one row of a database to calculate a first shipping rate value for a first type of shipping rate, among a plurality of types of shipping rates, associated with a first rate identifier;
program code instructions configured to define content in the at least one row to analyze at least one predecessor rate identifier of a previously generated source of rates;
program code instructions configured to detect a second shipping rate value corresponding to the predecessor rate identifier of the source of rates, the detected second shipping rate value is associated with a second type of shipping rate; and
program code instructions configured to determine the first shipping rate value for the first type of shipping rate based in part on calculating the first formula using the second shipping rate value of the source of rates.

22. The computer program product of claim 21, wherein:
the second type of shipping rate corresponds to a published type shipping rate that a shipping carrier publishes as a base shipping rate.

23. The computer program product of claim 22, wherein:
the first type of shipping rate corresponds to a contract type shipping rate corresponding to a discount off of the published type shipping rate.

24. The computer program product of claim 21, further comprising:
program code instructions configured to define in another row of the database a second formula to calculate a third shipping rate value for a third type of shipping rate, among the plurality of types of shipping rates, associated with a second rate identifier;
program code instructions configured to define content in the another row to analyze at least one other predecessor rate identifier which comprises the first rate identifier;
program code instructions configured to detect the determined first shipping rate value corresponding to the first rate identifier in response to analyzing the at least one other predecessor rate identifier; and
program code instructions configured to determine the third shipping rate value for the third type of shipping rate based in part on calculating the second formula using the determined first shipping rate value for the first type of shipping rate.

25. The computer program product of claim 24, wherein:
the third type of shipping rate corresponds to a retail type shipping rate pertaining to a markup of the first shipping rate value for the first type of shipping rate.
